(19) United States
(12) Patent Application Publication
(10) Pub. No.: US 2020/0096821 A1
(43) Pub. Date: Mar. 26, 2020

(54) PLANAR LIGHTING DEVICE AND DISPLAY DEVICE

(71) Applicant: SHARP KABUSHIKI KAISHA, Sakai City, Osaka (JP)

(72) Inventors: YOUZOU KYOUKANE, Sakai City, Osaka (JP); HISASHI WATANABE, Sakai City, Osaka (JP); HIROTOSHI YASUNAGA, Sakai City, Osaka (JP)

(21) Appl. No.: 16/495,336

(22) PCT Filed: Mar. 22, 2018
(86) PCT No.: PCT/JP2018/011299

§ 371 Date: Sep. 18, 2019

(30) Foreign Application Priority Data
Mar. 29, 2017 (JP) 2017-065359

(51) Int. Cl. G02F 1/1335

(52) U.S. Cl. CPC G02F 1/133605; G02F 1/133608; G02F 2001/133601; G02F 1/133603; G02F 2001/133612; G02F 1/133606

(57) ABSTRACT

Influence of expansion or contraction of a light guiding member, which is caused by a temperature change, on illumination light is reduced. In a casing (17) of a planar lighting module (4), an LED (15) is fixed, a plurality of diffusing plates (20) each having a reflection pattern (21) and a pin-receiving portion (24) are stored, and a pin frame (34) that corresponds to the pin-receiving portion (24) is disposed. Each of the diffusing plates (20) is positioned with respect to the casing (17) when the pin-receiving portion (4) is fitted with the pin frame (34).

### TECHNICAL FIELD

The present invention relates to a planar lighting device and a display device using the planar lighting device.

### BACKGROUND ART

In recent years, with spread of an LED (light emitting diode), adoption of a planar lighting device of a so-called direct type which has a light source disposed behind a light emitting surface of the planar lighting device as a backlight of a display device has increased. Moreover, adoption of local dimming drive of the light source along with the direct type enables contrast of a display image to be enhanced. Thus, also for pursuing high brightness and high image quality, the adoption of the planar lighting device of the direct type as the backlight has increased.

For example, PTL 1 discloses a planar lighting device of a direct type, which is usable for a backlight. In the planar lighting device described in PTL 1, a main incident surface of a light guiding member is opposite to a main emitting surface of the light guiding member. Furthermore, in order to obtain illumination light that is uniform, a reflection pattern that corresponds to a light source is disposed on the main incident surface or the main emitting surface.

### CITATION LIST

### Patent Literature

PTL 1: Japanese Unexamined Patent Application Publication No. 2008-27886 (published on Feb. 7, 2008)

### SUMMARY OF INVENTION

### Technical Problem

However, in the conventional planar lighting device described above, there is a problem that expansion or contraction of the light guiding member, which is caused by a temperature change, has influence on illumination light.

For example, FIG. 15 is a sectional view illustrating a schematic configuration of a conventional planar lighting device 104. As illustrated in FIG. 15, the planar lighting device includes a casing 117 that has an inner surface covered with a reflection sheet 116, a plurality of LEDs 115 that are fixed to the casing 117, and a diffusing plate 120 on which a reflection pattern 121 is formed and which is stored in the casing 117. Light radiated by the LEDs 115 is emitted externally through the diffusing plate 120 directly or after being reflected by the reflection pattern 121 or the reflection sheet 116.

Accordingly, disposition of the reflection pattern 121 with respect to the LED 115 has influence on distribution and uniformity of illumination light. Thus, for example, as in FIG. 16(a), in order to obtain uniform illumination light in an initial state (state before undergoing a temperature change), the diffusing plate 120 is disposed so that the reflection pattern 121 and the LED 115 match in disposition. However, the diffusing plate 120 expands or contracts due to a temperature change. As a result, for example, as in FIG. 16(b), in a high-temperature or low-temperature state (state after undergoing a temperature change), the disposition of the reflection pattern 121 does not match the disposition of the LED 115, so that unevenness of illumination light is generated as in FIG. 16(c).

An aspect of the invention is made in view of the aforementioned problem and an object thereof is to achieve a planar lighting device that is capable of reducing influence of expansion or contraction of a light guiding member, which is caused by a temperature change, on illumination light.

### Solution to Problem

In order to solve the aforementioned problem, a planar lighting device according to an aspect of the invention include light source unit that radiates light; a plurality of optical members each of which (i) includes a light-transmitting pattern allowing the light to transmit and (ii) expands or contracts due to a temperature change; and a casing (i) to Which the light source unit is fixed, (ii) which includes an opening allowing the light to transmit and which is an optical opening, and (iii) which stores the optical members between the light source unit and the opening, in which at least one of the optical members includes an optical member positioning unit, the casing includes a casing positioning unit that corresponds to the optical member positioning unit, and the at least one of the optical members is positioned with respect to the casing by the optical member positioning unit being fitted with the corresponding casing positioning unit.

### Advantageous Effects of Invention

According to an aspect of the invention, it is possible to reduce influence of expansion or contraction of an optical member, which is caused by a temperature change, on illumination light.

### BRIEF DESCRIPTION OF DRAWINGS

FIG. 1 is a sectional view illustrating a schematic configuration of a liquid crystal display device that uses a planar lighting module according to an embodiment of the invention.

FIG. 2 is a top view illustrating an example of a schematic configuration of the planar lighting module illustrated in FIG. 1.

FIGS. 3(a) and 3(b) are respectively a top view and a sectional view as viewed in an arrow direction of A-A, which illustrate another example of the schematic configuration of the planar lighting module illustrated in FIG. 1.

FIGS. 4(a) and 4(b) are respectively a sectional view and a perspective view of a back surface of an LED substrate, which illustrate an example of a schematic configuration of a pin frame and the LED substrate illustrated in FIG. 3(b).

FIG. 5 is a sectional view illustrating an example of a schematic configuration of another planar lighting module that is a modified example of the planar lighting module illustrated in FIG. 1.

FIGS. 6(a) and 6(b) are a sectional view and an enlarged perspective view of a section taken along a box B, which illustrate a schematic configuration of a planar lighting module according to another embodiment of the invention.

FIGS. 7(a) and 7(b) are sectional views respectively illustrating a contracting state and an expanding state of the diffusing plates due to a temperature change, which are illustrated in FIG. 6 and adjacent to each other.

FIGS. 8(a) and 8(b) are respectively a top view and a perspective view, which illustrate a schematic configuration of a planar lighting module according to another embodiment of the invention.

FIGS. 9(a), 9(b), and 9(c) are respectively a top view, a bottom view, and a sectional view as viewed in an arrow direction of D-D, which illustrate a schematic configuration of a diffusing plate illustrated in FIG. 8.

FIG. 10 is a sectional view as viewed in an arrow direction of C-C of FIG. 8(a).

FIGS. 11(a) and 11(b) are respectively a top view and a sectional view as viewed in an arrow direction of E-E, which illustrate a schematic configuration of a planar lighting module according to another embodiment of the invention.

FIGS. 12(a) and 12(b) are respectively a sectional view and a top view, which illustrate a schematic configuration of a planar lighting module according to another Embodiment of the invention.

FIG. 13 is a sectional view illustrating a schematic configuration of a planar lighting module according to another Embodiment of the invention.

FIGS. 14(a), 14(b), and 14(c) are respectively a top view, a bottom view, and a sectional view as viewed in an arrow direction of F-F, which illustrate a schematic configuration of a light guiding member 40 illustrated in FIG. 13.

FIG. 15 is a sectional view illustrating a schematic configuration of a conventional planar lighting device.

FIGS. 16(a), 16(b), and 16(c) are respectively a sectional view illustrating disposition of a reflection pattern with respect to the LED in an initial state, a sectional view illustrating disposition of the reflection pattern with respect to the LED in an expanding or contracting state of a diffusing plate, and a top view illustrating unevenness of illumination light in the expanding or contracting state of the diffusing plate, in the planar lighting device illustrated in FIG. 15.

Some embodiments of the invention will be described below in detail.

### EMBODIMENT 1

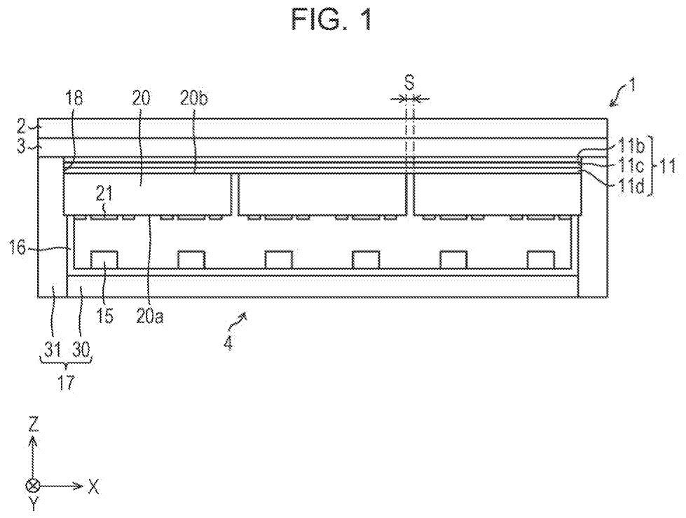

An embodiment of the invention will be described in detail with reference to FIGS. 1 to 5.

### Liquid Crystal Display Device

FIG. 1 is a sectional view illustrating schematic configuration of a liquid crystal display device 1 that uses a planar lighting module 4 according to Embodiment 1 of the invention.

As illustrated in FIG. 1, the liquid crystal display device 1 (display device) includes a liquid crystal panel 3, a cover glass 2 that protects a front surface of the liquid crystal panel 3, and the planar lighting module 4 (planar lighting device) that functions as a backlight of the liquid crystal panel 3. Note that, the liquid crystal display device 1 may include a touch panel instead of the cover glass 2 or between the cover glass 2 and the liquid crystal panel 3. The cover glass 2, the touch panel, and the liquid crystal panel 3 are bonded to each other by using an OCA (optical clear adhesive), which is a kind of transparent adhesive, or the like. Each of the cover glass 2, the touch panel, and the liquid crystal panel 3 may have any configuration, and various configurations are known, so that detailed description thereof will be omitted.

Hereinafter, an xyz orthogonal coordinate system in the present specification is constituted by an X-axis, a Y-axis, and a Z-axis that are defined as follows.
X-axis: a right-left direction of FIG. 1 and a direction parallel to a display surface of the liquid crystal display device 1
Y-axis: a depth direction of FIG. 1 and a direction parallel to the display surface of the liquid crystal display device 1 and orthogonal to the x-axis
Z-axis: an up-down direction of FIG. 1 and a direction orthogonal to the display surface of the liquid crystal display device 1

### Planar Lighting Module

### Light Source Unit

As illustrated in FIG. 1, the planar lighting module 4 has a plurality of LEDs 15, which radiate light, as a light source unit.

An LED of a so-called top-view light emission type is preferably used as an LED 15. The LED of the so-called top-view light emission type is an LED of a type in which, when a surface on which an anode electrode and a cathode electrode of the LED are provided is assumed to be a lower surface of the LED, a light emitting surface of the LED is a top surface of the LED. The LEDs 15 are arranged on the planar lighting module 4 so that a light emitting surface thereof faces the display surface of the liquid crystal display device 1.

Each of the LEDs 15 may be one element or a chip LED including two or more elements. For example, in a case where illumination light from the planar lighting module 4 is white light, the LED 15 may be, for example, a chip LED in which a blue LED element is sealed in resin containing a yellow phosphor or a chip LED in which a blue LED element, a red LED element, and a green LED element are integrally sealed.

Each of the LEDs 15 is preferably wired so that driving control is able to be performed individually. This is because local diming drive enables contrast of a display image, which is displayed by the liquid crystal display device 1, to be enhanced. Note that, the planar lighting module 4 may include another kind of light source, and may include, for example, a fluorescent light that is not suitable for the local dimming drive.

### Diffusing Plate

As illustrated in FIG. 1, the planar lighting module 4 further includes, as a plurality of optical members, a plurality of diffusing plates 20 between the LEDs 15 and the liquid crystal panel 3.

A diffusing plate 20 is a diffusing plate in which a reflection pattern 21 that is capable of reflecting light emitted from the LED 15 is disposed on a light transmitting member that is formed from a transparent material that allows transmission of the light emitted from the LED. The diffusing plate 20 includes, on a side of the LED 15, a main incident surface 20a on which the light emitted from the LED 15 is incident. The diffusing plate 20 includes, on a side opposite to the LED 15 (side of the liquid crystal panel 3), a main emitting surface 20b from which the light, which is incident from the main incident surface 20a and transmitted through the diffusing plate 20, is emitted. The main incident surface 20a and the main emitting surface 20b are surfaces of the diffusing plate 20, which spread so as to be parallel to an XY plane and face away from each other.

The diffusing plate 20 reflects light that is incident on the main incident surface 20a and incident on a region where the reflection pattern 21 is provided, and emits, from the main emitting surface 20b, light that is incident on the main incident surface 20a and incident on a region where the reflection pattern 21 is not provided. Accordingly, the diffusing plate 20 has a light-transmitting pattern, and the light-transmitting pattern is complementary to the reflection pattern 21. In other words, the light-transmitting pattern included in the diffusing plate 20 is a pattern reverse to the reflection pattern 21.

The light transmitting member used in the diffusing plate 20 expands or contracts in accordance with a temperature change. It is preferable that the light transmitting member used in the diffusing plate 20 has high diffusibility for diffusing light radiated by the LED 15. Such a light transmitting member is able to be formed by mixing a scatterer, which is able to scatter the light radiated by the LED 15, in transparent plastic resin having high transparency, such as polycarbonate (PC) resin, acrylic resin, silicone resin, or polymethyl methacrylate (PMMA) resin, or in another transparent material such as glass, for example. The light transmitting member as above seems to be tinged with milky white and therefore is also called a milky white plate in some cases. For example, in a case where the diffusing plate 20 is manufactured to have a width of about 100 mm in an x-direction at +25° C. by using a light transmitting member formed from PC resin and a scatterer, a coefficient of linear expansion of the light transmitting member formed from the PC resin is normally about 6.5 10−5[/° C.], so that a temperature change in a range from +25° C. to +95° C. causes the width of the diffusing plate 20 in the x-direction to expand by about 0.455 mm.

The reflection pattern 21 is designed so as to correspond to intensity distribution of light radiated by the LED 15, and the diffusing plate 20 is disposed so that the reflection pattern 21 and the LED 15 match in disposition. The reflection pattern 21 is a reflection pattern capable of reflecting the light radiated by the LED 15. In order to uniformize illumination light, it is preferable that the reflection pattern 21 is able to reflect at least light radiated directly above the LED 15.

Specifically, for example, the reflection pattern 21 may be a dot pattern printed with white ink having high reflectivity on the main incident surface 20a of the diffusing plate 20. Moreover, for example, the reflection pattern 21 may also be a dot pattern in which the main incident surface 20a of the diffusing plate 20 is formed in a convex shape and/or a concave shape. Furthermore, in the present embodiment, the reflection pattern 21 is disposed only on the main incident surface 20a, but is not limited thereto, and may be disposed on both the main incident surface 20a and the main emitting surface 20b, may be disposed only on the main emitting surface 20b, or may be embedded inside the diffusing plate 20.

The number of diffusing plates 20 is not limited to three, and may be two, or may be four or more.

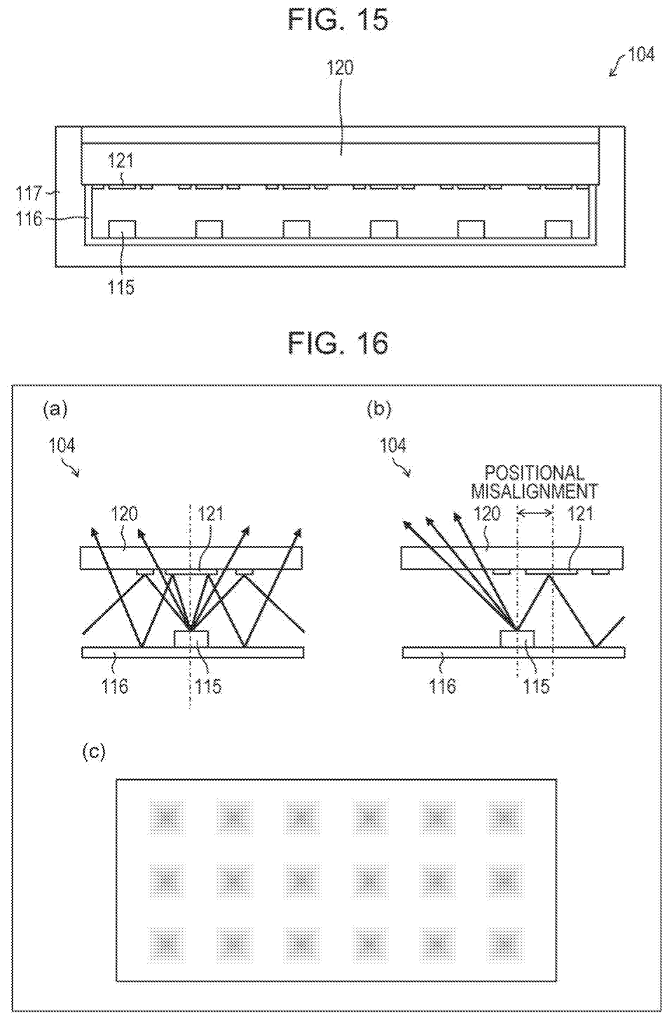

The conventional planar lighting device 104 illustrated in FIG. 15 includes the reflection pattern 121 on one diffusing plate 120, whereas the planar lighting module 4 according to Embodiment 1 of the invention, which is illustrated in FIG. 1, includes the reflection pattern 21 on the plurality of diffusing plates 20 in a divided manner.

### Optical Sheet

As illustrated in FIG. 1, the planar lighting module 4 further includes an optical sheet 11 between the diffusing plate 20 and the liquid crystal panel 3.

The optical sheet 11 is able to fix light, which is emitted from the main emitting surface 20b of the diffusing plate 20, to be uniform illumination light. The optical sheet 11 has a configuration in which a first prism sheet 11b, a second prism sheet 11c whose prism extension direction is orthogonal to that of the first prism sheet 11b, and a first diffusion sheet 11d are layered in order from the side of the liquid crystal panel 3 to the side of the LED 15, for example. The configuration of the optical sheet 11 is not limited thereto. Various configurations are known as a possible configuration of the optical sheet 11, so that detailed description thereof will be omitted.

### Casing

As illustrated in FIG. 1, the planar lighting module 4 further includes a casing 17.

The casing 17 includes an LED substrate 30 to which the LED 15 is fixed and an outer-periphery frame 31 which is fixed to the LED substrate 30. Note that, the LED substrate 30 also includes other components of a wire for wiring the LED 15, sealing resin, a control circuit, and the like in addition to the LED 15, but illustration and description thereof will be omitted.

The LED 15, the diffusing plate 20, and the optical sheet 11 are stored in an inside of the casing 17. Among the LED 15, the diffusing plate 20, and the optical sheet 11, the LED 15 is mounted on and fixed to the LED substrate 30, and is thereby immovably fixed to the casing 17. On the other hand, there is room for sliding respect to the casing 17 because the diffusing plate 20 and the optical sheet 11 are not fixed to the casing 17.

It is preferable that a reflection sheet 16 that is capable of reflecting the light radiated by the LED 15 is stuck to an inner surface of the casing 17. For example, first, the LED 15 is mounted on a top surface of the LED substrate 30 and then the reflection sheet 16 is stuck to the top surface of the LED substrate 30. Next, the reflection sheet 16 is stuck to an inner surface of the outer-periphery frame 31, and then the outer-periphery frame 31 is engaged with the LED substrate 30.

The casing 17 includes an opening 18 through which the light radiated by the LED 15 is able to pass. An opening plane on which an opening of the opening 18 spreads is parallel to the XY plane and an opening axis that is orthogonal to the opening plane is parallel to the Z-axis. The opening 18 faces the liquid crystal panel 3 in the liquid crystal display device 1. In Embodiment 1, the opening 18 is a mechanical opening, but is not limited thereto, and may be any optical opening as long as the opening allows passage or transmission of the light radiated by the LED 15.

The casing 17 stores the optical sheet 11 between the opening 18 and the LED 15. Thus, light emitted to an outside of the casing 17 through the opening 18 is transmitted through the optical sheet 11. Moreover, the casing stores the diffusing plate 20 between the opening 18 and the LED 15. Thus, a most part of the light emitted to the outside of the casing 17 through the opening 18 is transmitted through the diffusing plate 20. Note that, in a case where a space of a gap S in the X-direction is sufficiently small and disposition of the gap S with respect to the LED 15 is suitable, all of the light emitted to the outside of the casing 17 through the opening 18 is transmitted through the diffusing plate 20.

The LED substrate 30 is, for example, a rigid substrate and functions as a bottom of the casing 17, but is not limited thereto. For example, the LED substrate 30 may be a flexible substrate, and the casing 17 may have a bottom separately from the LED substrate 30, and the LED substrate 30 may be fixed to the bottom of the casing 17.

The LED substrate 30 is connected to a power source substrate, a control substrate, and the like, and a voltage is applied to the LED 15 via the LED substrate 30. This makes it possible to control light emission of the LED 15.

In order to make it possible to expansion or contraction of the diffusing plate 20, the outer-periphery frame 31 may be formed from an elastic material such as silicone rubber, but not limited thereto. The outer-periphery frame 31 may be formed only from a rigid material or may be formed from a combination of the elastic material and the rigid material. In a case where a protrusion portion 32 is formed from the rigid material, a space (clearance) is preferably secured between the protrusion portion 32 and a notch portion 22 so that deformation is not caused on the protrusion portion 32 or the notch portion 22.

### Illumination Light

According to the aforementioned configuration, the planar lighting module 4 is able to emit uniform illumination light from the opening 18.

The LED 15 radiates light upward. Moreover, the reflection sheet 16 is stuck to the inner surface of the casing 17, and the casing 17 has the opening 18. Thus, in disregard of light absorption in the inside of the casing 17, the light radiated by the LED 15 is incident on the light-transmitting pattern (pattern reverse to the reflection pattern 21, specifically, the region where the reflection pattern 21 of the main incident surface 20a is not disposed) of the diffusing plate 20 directly or after being reflected by the reflection pattern 21 and the reflection sheet 16 a plurality of times.

Therefore, the light radiated by the LED 15 is emitted from the main emitting surface 20b after being reflected or diffused between the main incident surface 20a and the inner surface of the casing 17. Thus, intensity distribution of the light emitted from the main emitting surface 20b is more uniform than that of the light radiated by the LED 15. The light emitted from the main emitting surface 20b is more uniformized by the optical sheet 11. Accordingly, the planar lighting module 4 is able to emit uniform illumination light from the opening 18.

In such a structure, in order to uniformize illumination light, it is important that the reflection pattern 21 and the LED 1 match in disposition, that is, positional misalignment of the diffusing plate 20 with respect to the casing 17 is little. This is because a degree at which the light emitted from the main emitting surface 20b is more uniformized than the light radiated by the LED 15 is influenced.

### Positioning Unit

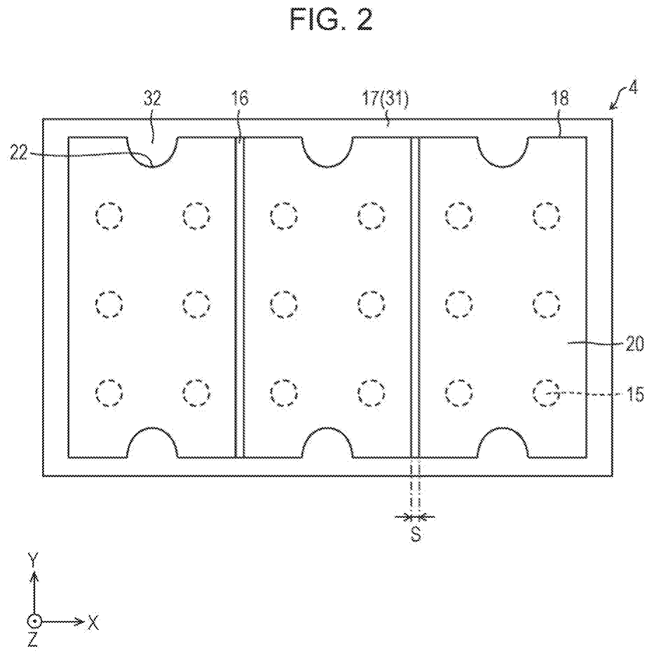

FIG. 2 is a top view illustrating an example of a schematic configuration of the planar lighting module 4 illustrated in FIG. 1. Note that, for convenience of illustration, illustration of the optical sheet 11 and the reflection pattern 21 will be omitted.

As illustrated in FIG. 2, each of the diffusing plates 20 includes the notch portion 22 as an optical member positioning unit. Moreover, the casing 17 includes the protrusion portion 32, which corresponds to the notch portion 22, in the outer-periphery frame 31 as a casing positioning unit. The casing 17 stores the diffusing plate 20 in such a manner that the notch portion 22 is fitted with the corresponding protrusion portion 32, so that the diffusing plate 20 is positioned with respect to the casing 17.

The notch portion 22 and the protrusion portion 32 that correspond to each other preferably have shapes that are complementary to each other so that the fitting is allowed. Each of the shapes of the notch portion 22 and the protrusion portion 32 that correspond to each other may be any shape, for example, such as a semicircular shape, a triangular shape, or a rectangular shape.

By being positioned by the fitting of the notch portion 22 and the protrusion portion 32, when expanding or contracting due to a temperature change, the diffusing plate 20 expands or contracts with the notch portion 22 as a center. Specifically, since the notch portion 22 is fitted with the protrusion portion 32, the diffusing plate 20 that expands or contracts is slid with respect to the casing 17 so that the notch portion 22 does not move with respect to the protrusion portion 32. Thus, positional misalignment between the diffusing plate 20 and the casing 17 is reduced to (distance to an end of the diffusing plate 20, which is farthest from the notch portion 22) (coefficient of linear expansion of the light transmitting member forming the diffusing plate 20) or less. Furthermore, the planar lighting module 4 according to Embodiment 1 of the invention includes the plurality of diffusing plates 20, so that the distance to the end of the diffusing plate 20, which is farthest from the notch portion 22, is short compared with a configuration in which only one diffusing plate is provided. Accordingly, the positional misalignment between the diffusing plate 20 and the casing 17 is able to be further reduced.

Moreover, by the positioning by the fitting of the notch portion 22 and the protrusion portion 32, in a manufacturing process, it is easy to store the diffusing plate 20 at a suitable position with respect to the casing 17. Thus, the positional misalignment between the diffusing plate 20 and the casing 17 is able to be further reduced. In this manner, the positional misalignment between the diffusing plate 20 and the casing 17 is reduced, so that matching property in disposition of the reflection pattern 21 and the LED 15 is able to be enhanced and kept high.

Since the diffusing plate 20 expands or contracts with the notch portion 22 as the center, the notch portion 22 is preferably provided at each of two end portions of the diffusing plate 20, which are opposite to each other, and is more preferably provided at the same position of each of the two end portions, and is further more preferably provided at a center of each of the two end portions.

Note that, the optical member positioning unit included in the diffusing plate 20 and the casing positioning unit included in the casing 17 may have any structure as long as the fitting with each other is allowed. For example, on the contrary to FIG. 2, the diffusing plate 20 may include a protrusion portion as the optical member positioning unit and the casing 17 may include a notch portion as the casing positioning unit.

### Gap

The gap S is provided between the diffusing plates 20 that are adjacent to each other in the X-direction. The space of the gap S in the X-direction preferably has a width that allows absorbing expansion or contraction of a width of the diffusing plate 20 in the X-direction in a temperature range in an environment in which it is assumed that the diffusing plate 20 is used.

The light radiated by the LED 15 is able to pass or is able to be transmitted through the gap S. Therefore, the light is not blocked between the diffusing plates 20 that are adjacent to each other, so that a shadow due to the gap S is not generated. Moreover, it is preferable that the space of the gap S in the x-direction is as small as possible so that a bright point or a bright line due to the gap S is not generated.

Thus, it is preferable that the space, of the gap S in the X-direction is set by considering a manufacture error including assembling unevenness or dimension tolerance, an effect of the positioning by the notch portion 22 and the protrusion portion 32, a space (clearance) secured between members, a coefficient of linear expansion, a width in the X-direction, and a shape of the diffusing plate 20, and a temperature change in an environment in which it is assumed that the diffusing plate 20 is used. Specifically, it is preferable that, at a highest temperature in an assumed use environment, the space of the gap S in the X-direction is set so that facing end surfaces of the diffusing plates 20 that are adjacent to each other in the X-direction are just in contact with each other or are slightly separated.

It is preferable that the width of the diffusing plate 20 in the X-direction is set by considering permissible positional misalignment between the LED 15 and the reflection pattern 21 a manufacture error including assembling unevenness or dimension tolerance, the effect of the positioning by the notch portion 22 and the protrusion portion 32, a space (clearance) secured between members, and the coefficient of linear expansion and the shape of the diffusing plate 20. For example, in a case where the diffusing plate 20 a temperature range of an assumed use environment of which is from −40° C. to +95° C. is manufactured by using a light transmitting member whose coefficient of linear expansion is about 6.5 10−5/° C., the width of the diffusing plate 20 in the X-direction is preferably 100 mm or less at 25° C.

### Modified Example 1 of Embodiment 1

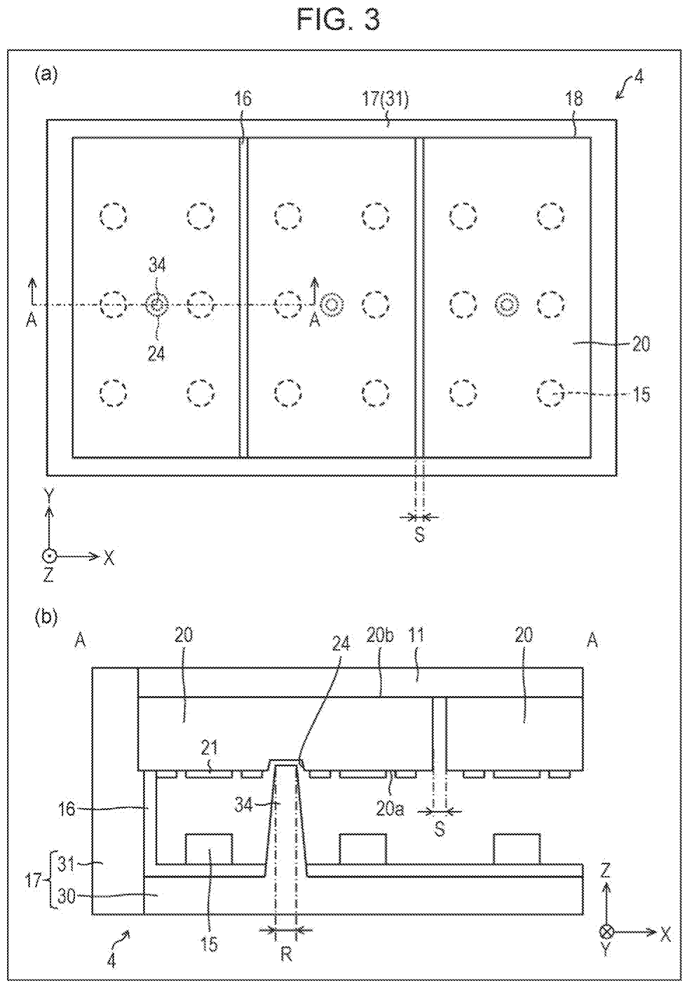

FIGS. 3(a) and 3(b) are respectively a top view and a sectional view as viewed in an arrow direction of A-A, which illustrate another example of the schematic configuration of the planar lighting module 4 illustrated in FIG. 1. Note that, for convenience of illustration, illustration of the optical sheet 11 and the reflection pattern 21 will be omitted from FIG. 3(a).

As illustrated in FIG. 3, the diffusing plates 20 respectively include pin-receiving portions 24 as the optical member positioning unit. Moreover, the casing 17 includes, as the casing positioning unit, pin frames 34 (pin-shaped protrusion portions) that correspond to the pin-receiving portions 24 in the LED substrate 30. The casing 17 stores the diffusing plates 20 in such a manner that each of the pin-receiving portions 24 is fitted with the corresponding one of the pin frames 34, so that the diffusing plates 20 are positioned with respect to the casing 17.

The schematic configuration illustrated in FIG. 3 is different from the schematic configuration illustrated in FIG. 2 in two points that (i) the diffusing plate 20 includes the pin-receiving portion 24 instead of the notch portion 22 and (ii) the casing 17 includes the pin frame 34 instead of the protrusion portion 32, but is similar in other configurations.

The pin-receiving portion 24 and the pin frame 34 that correspond to each other preferably have shapes that are complementary to each other so that the fitting is allowed. The shape of the pin frame 34 may be any pin shape, for example, such as a cone shape, a column shape, or a frustum shape. The shape of the pin-receiving portion 24 may be any shape as long as the shape allows receiving an edge of the corresponding pin frame 34, and is preferably able to include a shape of a bottomed hole having a bottom with which the edge of the corresponding pin frame is able to be in contact.

By being positioned by the fitting of pin-receiving portion 24 and the pin frame 34, when expanding or contracting due to a temperature change, the diffusing plate 20 expands or contracts with the pin-receiving portion 24 as a center. Specifically, since the edge of the pin frame 34 is fitted with an inside of the pin-receiving portion 24, the diffusing plate 20 that expands or contracts is slid with respect to the casing 17 so that the pin-receiving portion 24 does not move with respect to the casing 17. Thus, it is preferable that the pin-receiving portion 24 is provided at a center of the main incident surface 20a of the diffusing plate 20.

### Pin Frame

The pin frame 34 is disposed on the LED substrate 30 so as to protrude toward the diffusing plate 20 from the casing 17.

In order to make it possible to follow expansion or contraction of the diffusing plate 20, the pin frame 34 may be formed from an elastic material such as silicone rubber, but not limited thereto. The pin frame 34 may be formed only from a rigid material or may be formed from a combination of the elastic material and the rigid material. Preferably, the pin frame 34 has sufficient mechanical intensity for a support unit that is able to support the diffusing plate 20 and the optical sheet 11. By supporting the diffusing plate 20 and the optical sheet 11 by the pin frame 34, it is possible to reduce deflection of the diffusing plate 20 and the optical sheet 11. Additionally, in a case where the edge of the pin frame 34 is formed from the rigid material, a space (clearance) is preferably secured between the edge of the pin frame 34 and the pin-receiving portion 24 so that deformation is not caused on the edge of the pin frame 34 or the pin-receiving portion 24.

The pin frame 34 is preferably able to reflect the light radiated by the LED 15, and is able to be formed from, for example, white PC resin. Furthermore, the pin frame 34 is also preferably able to transmit the light radiated by the LED 15, and is able to be formed from, for example, transparent PC resin or PMMA resin.

A diameter R of the edge of the pin frame 34 is preferably as small as possible so that unevenness of illumination light, which is caused by the pin frame 34, is reduced, and, specifically, is preferably 2 mm or less.

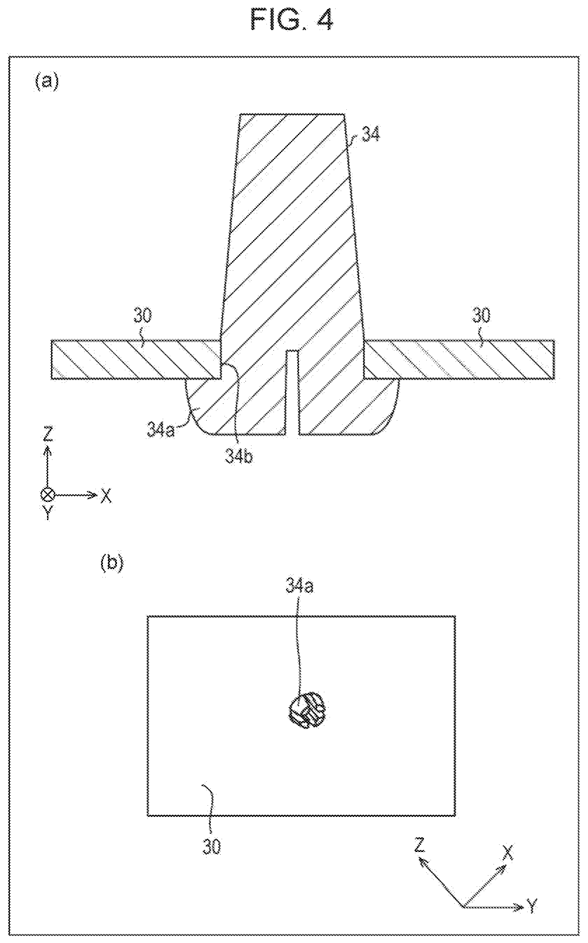

FIGS. 4(a) and 4(b) are respectively a sectional view and a perspective view of a back surface of the LED substrate 30, which illustrate an example of a schematic configuration of the pin frame 34 and the LED substrate 30 illustrated in FIG. 3(b).

As illustrated in FIG. 4, the pin frame 34 includes a claw 34a at a root on a side opposite to the edge that is fitted with the pin-receiving portion 24. The LED substrate 30 includes a through hole 34b into which the pin frame 34 is inserted. The pin frame 34 is inserted into the through hole 34b from the edge of the pin frame 34 through a rear surface (surface on a side opposite to a mounting surface on which the LED 15 is mounted) of the LED substrate 30 toward the mounting surface. When the claw 34a interlocks with the LED substrate 30, the pin frame 34 that is inserted is fixed to the LED substrate 30.

Note that, the pin frame 34 may be formed integrally with the LED substrate 30, but is preferably formed separately from the LED substrate 30 as illustrated in FIG. 4 because manufacturing of the casing 17 is easy. Moreover, the pin frame 34 may be fixed to the LED substrate 30 by means other than the claw 34a, but is preferably fixed by the claw 34a as illustrated in FIG. 4 because efficiency of an assembling process in which the pin frame 34 is fixed to the LED substrate 30 is increased.

### Modified Example 2 of Embodiment 1

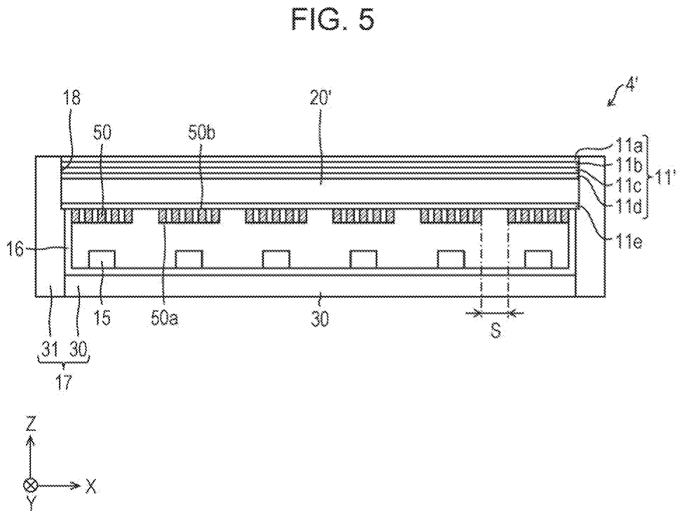

FIG. 5 is a sectional view illustrating air example of a schematic configuration of another planar lighting, module that is a modified example of the planar lighting module 4 illustrated in FIG. 1.

As illustrated in FIG. 5, the planar lighting module 4′ includes a diffusing plate 20′ which does not include a reflection pattern. The planar lighting module 4′ includes, as a plurality of optical members, a plurality of opening-provided reflection plates 50 between the diffusing plate 20′ and the LEDs 15. The planar lighting module 4′ has an optical sheet 11′ provided on the diffusing plate 20′ on the side opposite to the opening-provided reflection plates 50, and has a second diffusion sheet 11e provided between the opening-provided reflection plates 50 and the diffusing plate 20′. Additionally, the planar lighting module 4′ includes the LED 15 and the casing 17.

The schematic configuration of the planar lighting module 4′ illustrated in FIG. 5 is different from the schematic configuration of the planar lighting module 4 illustrated in FIG. 1 in two points of (i) not including the optical sheet 11 nor the diffusing plate 20 which includes the reflection pattern 21 and (ii) including the diffusing plate 20′ which does not include a reflection pattern, the optical sheet 11′, the second diffusion sheet 11e, and an opening-provided reflection plate 50, but is similar in other configurations.

### Optical Sheet

The optical sheet 11′ is able to fix light, which is emitted from a main emitting surface 50b of the opening-provided reflection plate 50, to be uniform illumination light. The optical sheet 11′ has a configuration in which, for example, a deflection-reflection sheet 11a that is a dual brightness enhancement film (DBEF), the first prism sheet 11b, the second prism sheet 11c whose prism extension direction is orthogonal to that of the first prism sheet, and the first diffusion sheet 11d are layered in order from an outside to the side of the LED 15, but is not limited thereto. The second diffusion sheet 11e is a diffusion sheet that is the same as or different from the first diffusion sheet 11d. Various configurations are known as possible configurations of the optical sheet 11′ and the second diffusion sheet 11e, so that detailed description thereof will be omitted.

### Reflection Plate

The opening-provided reflection plate 50 is a reflection plate obtained by providing a reflector, which includes a surface capable of reflecting the light emitted from the LED 15, with an opening pattern which penetrates the reflector. The opening-provided reflection plate 50 includes, on the side of the LED 15, a main incident surface 50a on which the light radiated by the LED 15 is incident. The opening-provided reflection plate 50 includes, on the side opposite to the LED 15, the main emitting surface 50b from which light that is incident from the main incident surface 50a and passes through the opening is emitted. The main incident surface 50a and the main emitting surface 50b are surfaces of the opening-provided reflection plate 50, which spread so as to be parallel to the XY plane and face to each other. Note that, in the present modified example, the opening pattern is a mechanical opening, but is not limited thereto, and may be any optical opening as long as the opening allows passage or transmission of the light radiated by the LED 15.

The opening-provided reflection plate 50 reflects light that is incident on the main incident surface 50a and incident on a region where the opening is not provided, and emits, from the main emitting surface 20b, light that is incident on the main incident surface 50a and passes through the opening. Accordingly, the diffusing plate 20′ includes a light-transmitting pattern, and the light-transmitting pattern is the opening pattern of the opening-provided reflection plate 50.

The reflector used in the opening-provided reflection plate 50 expands or contracts in accordance with a temperature change. The reflector used in the opening-provided reflection plate 50 is able to be formed from white resin, metal, or the like, which has high reflectivity, and the surface thereof is preferably subjected to mirror surface processing.

The opening pattern of the opening-provided reflection plate 50 is formed so as to correspond to arrangement of the LEDs 15. In order to uniformize illumination light, it is preferable that the opening pattern does not allow passage of at least light radiated directly above the LED 15.

As above, the light-transmitting pattern is included in (i) the diffusing plate 20 in the planar lighting module 4 illustrated in FIG. 1, and, on the contrary, is included in (ii) the opening-provided reflection plate 50 in the planar lighting module 4′ illustrated in FIG. 5. Thus, in order to uniformize illumination light of the planar lighting module 4′, it is important that the opening pattern and the LED 15 match in disposition (accordingly, it is important that positional misalignment between the opening-provided reflection plate 50 and the casing 17 is little). This is because a degree at which the light emitted from the main emitting surface 50b is more uniformized than the light radiated by the LED 15 is influenced.

### Positioning Unit

Although illustration is omitted similarly to the diffusing plate 20 illustrated in FIG. 2 or 3, each of the opening-provided reflection plates 50 is able to include a notch portion or a pin-receiving portion as the optical member positioning unit. Moreover, it is possible that the casing 17 includes, as the casing positioning unit, (i) a protrusion portion, which corresponds to the notch portion, in the outer-periphery frame 31 or (ii) a pin frame, which corresponds to the pin-receiving portion, in the LED substrate 30.

By being positioned by the fitting of the optical member positioning unit and the casing positioning unit, when expanding or contracting due to a temperature change, the opening-provided reflection plate 50 expands or contracts with the optical member positioning unit as a center. Note that, similarly to the optical member positioning unit included in the diffusing plate 20′, the optical member positioning unit included in the opening-provided reflection plate 50 may have any structure as long as the fitting with the casing positioning unit included in the casing 17 is allowed.

### Gap

Similarly to the case of the diffusing plates 20′ that are adjacent to each other in the X-direction, the gap S is provided between opening-provided reflection plates 50 that are adjacent to each other in the X-direction. The space of the gap S in the X-direction is preferably a size that allows absorbing expansion or contraction of a width of the opening-provided reflection plate 50 in the X-direction in a temperature range in an environment in which it is assumed that the opening-provided reflection plate 50 is used. Moreover, it is preferable that the space of the gap S in the X-direction is as small as possible.

### EMBODIMENT 2

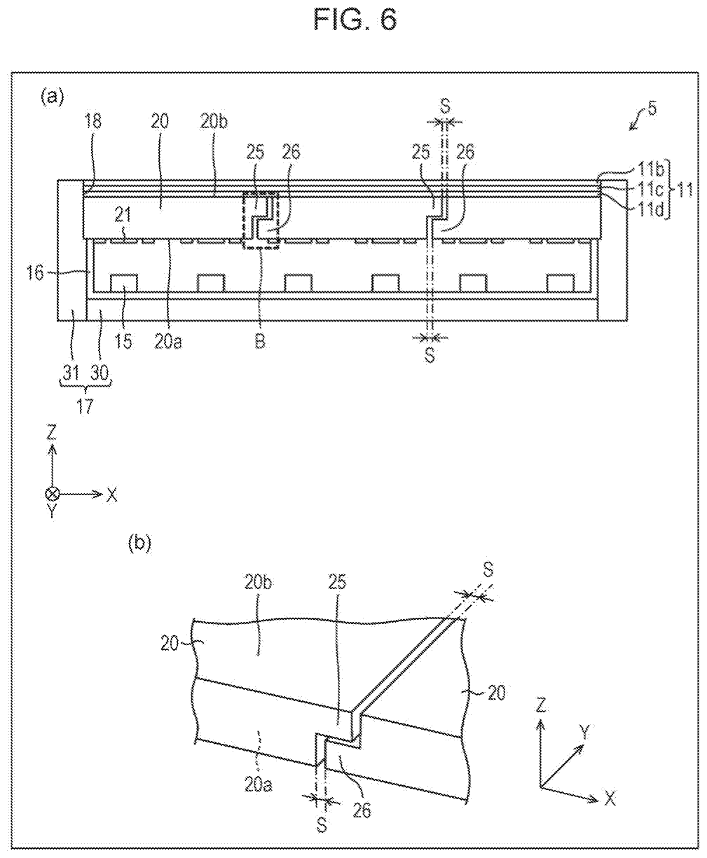

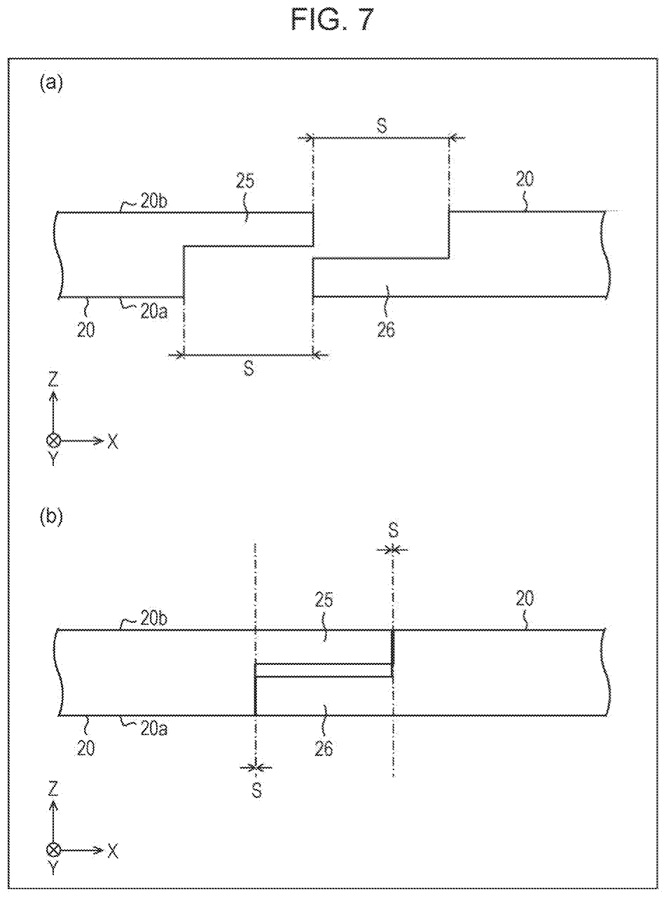

Another embodiment of the invention will be described as follows with reference to FIGS. 6 and 7. Note that, for convenience of description, a member having the same function as that of the member described in the aforementioned embodiment will be given the same reference sign and description thereof will be omitted.

FIGS. 6(a) and 6(b) are a sectional view and an enlarged perspective view of a section taken along a box B, which illustrate a schematic configuration of a planar lighting module 5 according to Embodiment 2 of the invention.

As illustrated in FIG. 6, the planar lighting module 5 includes the plurality of LEDs 15, the plurality of diffusing plates 20, the optical sheet 11, and the casing 17.

The schematic configuration of the planar lighting module 5 according to Embodiment 2 of the invention, which is illustrated in FIG. 6, is different from the schematic configuration of the planar lighting module 4 according to Embodiment 1, which is illustrated in FIG. 1, in that, as illustrated in FIG. 6(b) in an enlarged manner, end portions of diffusing plates 20 that are adjacent to each other are overlapped with each other, but is similar in other configurations.

### Diffusing Plate

As illustrated in FIG. 6, each of the diffusing plates 20 according to Embodiment 2 further includes an upper overlapped portion 25 and/or a lower overlapped portion 26 in addition to the reflection pattern 21 and the optical member positioning unit (example: the notch portion 22 of FIG. 2 or the pin-receiving portion 24 of FIG. 3).

A diffusing plate 20 on a left side of FIG. 6 has the upper overlapped portion 25 at a right end, and a diffusing plate 20 in a center of FIG. 6 has the lower overlapped portion 26 at a left end, and the upper overlapped portion 25 and the lower overlapped portion 26 are overlapped with each other in plan view seen from the z-direction. Similarly, the diffusing plate 20 in the center of FIG. 6 has the upper overlapped portion 25 at a right end, and a diffusing plate 20 on a right side of FIG. 6 has the lower overlapped portion 26 at a left end, and the upper overlapped portion 25 and the lower overlapped portion 26 are partially overlapped with each other in plan view seen from the z-direction.

In this manner, the diffusing plates 20 that are adjacent to each other in the X-direction respectively have the upper overlapped portion 25 and the lower overlapped portion 26 that correspond to each other, and the upper overlapped portion 25 and the lower overlapped portion 26 that correspond to each other are overlapped with each other. Thereby, the gap S between the diffusing plates 20 is divided into a right side of the upper overlapped portion 25 and a left side of the lower overlapped portion 26. Thus, it is difficult that the light radiated by the LED 15 passes through the gap S without being transmitted through the diffusing plate 20. Accordingly, a bright point or a bright line due to the gap S is less likely to be generated. Moreover, it becomes easy to enlarge the width of the gap S in the X-direction so that expansion or contraction of the width of the diffusing plate 20 in the X-direction is able to be absorbed and a bright point or a bright line is not generated.

Additionally, in the planar lighting module 4 according to Embodiment 1 described above, concerned is unevenness of illumination light caused by an interval (region where there is no diffusing plate 20 completely) between the diffusing plates 20, but in the planar lighting module 5 according to Embodiment 2, it is possible to reduce unevenness of illumination light because there is no interval between the diffusing plates 20 in plan view seen from the Z-direction.

In an example of the configuration illustrated in FIG. 6 neither the upper overlapped portion 25 nor the lower overlapped portion 26 is not disposed at an end portion of the diffusing plate 20, which faces the outer-periphery frame 31, but may be disposed. In a case where the upper overlapped portion 25 or the lower overlapped portion 26 is provided at the end portion of the diffusing plate 20, which faces the outer-periphery frame 31, a shape of a part of the outer-periphery frame 31, which faces the end portion, is preferably complementary to a shape of the end portion.

### Expansion or Contraction

It is preferable that the space of the gap S in the X-direction and widths of the upper overlapped portion 25 and the lower overlapped portion 26 in the X-direction are set by considering permissible positional misalignment between the LED 15 and the reflection pattern 21, a manufacture error including assembling unevenness or dimension tolerance, an effect of positioning by the notch portion 22 and the protrusion portion 32, a space (clearance) secured between members, the coefficient of linear expansion and the width in the X-direction of the diffusing plate 20, and a temperature change in an environment in which it is assumed that the diffusing plate 20 is used.

FIGS. 7(a) and 7(b) are sectional views respectively illustrating a contracting state and an expanding state of the diffusing plates 20 due to a temperature change, which are illustrated in FIG. 6 and adjacent to each other in the X-direction.

FIG. 7(a) illustrates the state in which the diffusing plates 20 contract so that the upper overlapped portion 25 and the lower overlapped portion 26 are just in contact with each other in plan view seen from the Z-direction. FIG. 7(b) illustrates the state in which the diffusing plates 20 expand so that the upper overlapped portion 25 and the lower overlapped portion 26 are completely overlapped with each other in plan view seen from the Z-direction.

It is preferable that the space of the gap S in the X-direction and the widths of the upper overlapped portion 25 and the lower overlapped portion 26 in the X-direction are set so that the diffusing plates 20 that are adjacent to each other in the X-direction are in the state illustrated in FIG. 7(a), the state illustrated in FIG. 7(b), or an intermediate state between the state illustrated in FIG. 7(a) and the state illustrated in FIG. 7(b).

Accordingly, the upper overlapped portion 25 and the lower overlapped portion 26 preferably have the same width in the X-direction, and more preferably have the same thickness in the Z-direction as well. It is preferable that the width of the upper overlapped portion 25 and the lower overlapped portion 26 in the X-direction is the same as the space of the gap S in the X-direction at a lowest temperature in an environment in which it is assumed that the diffusing plates 20 are used or slightly larger than the space.

### EMBODIMENT 3

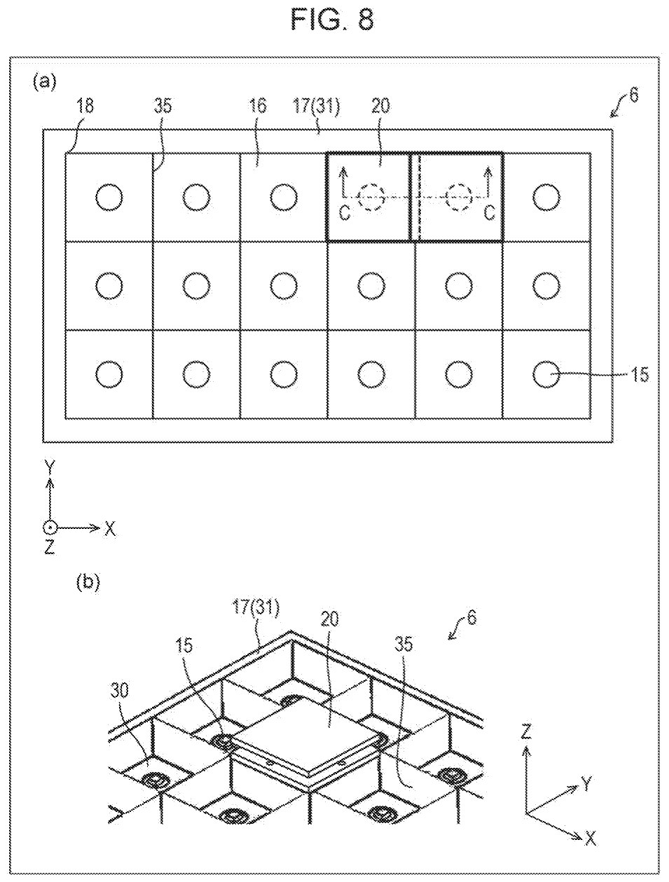

Another embodiment of the invention will be described as follows with reference to FIGS. 8 to 10. Note that, for convenience of description, a member having the same function as that of the member described in the aforementioned embodiment will be given the same reference sign and description thereof will be omitted.

FIGS. 8(a) and 8(b) are respectively a top view and a perspective view, which illustrate a schematic configuration of a planar lighting module 6 according to Embodiment 3 of the invention. Note that, for convenience of illustration, illustration of the optical sheet 11 and some of the plurality of diffusing plates 20 will be omitted.

As illustrated in FIG. 8, the planar lighting module 6 includes the plurality of LEDs 15, the plurality of diffusing plates 20, the optical sheet 11 (illustration thereof is omitted), and the casing 17.

The schematic configuration of the planar lighting module 6 according to Embodiment 3, which is illustrated in FIG. 8, is different from the schematic configuration of the planar lighting module 5 according to Embodiment 2, which is illustrated in FIG. 6, in three points that (i) the diffusing plates 20 are adjacent to each other in the Y-direction similarly to the X-direction, (ii) the casing 17 includes a lattice frame 35 as the casing positioning unit, and (iii) the diffusing plate 20 has structures (a projecting portion 26c and a recessed portion 25c) to be fitted with another diffusing plate 20, but is similar in other configurations.

### Lattice Frame

The lattice frame 35 (lattice-shaped protrusion unit) is disposed in the LED substrate 30 so as to protrude from the casing 17 toward the diffusing plate 20.

The lattice frame 35 has a shape of a wall that is disposed in a lattice pattern in plan view seen from the Z-direction. In Embodiment 3 illustrated in FIG. 8, the lattice frame 35 is disposed so that one segment of a lattice includes one LED 15. In this manner, a size of the diffusing plate 20 becomes small by finely disposing the lattice frame 35, so that the positional misalignment between the reflection pattern 21 and the LED 15, which is caused by expansion or contraction of the diffusing plate 20, is able to be reduced, thus it is preferable. Note that, the lattice frame 35 is also able to be disposed so that each lattice includes the plurality of LEDs 15.

The lattice frame 35 enhances rigidity of the casing 17, and thereby is able to enhance rigidity of the planar lighting module 6.

In order to make it possible to follow expansion or contraction of the diffusing plate 20, the lattice frame 35 may be formed from an elastic material such as silicone rubber, but not limited thereto. The lattice frame 35 may be formed only from a rigid material or may be formed from a combination of the elastic material and the rigid material. Preferably, the lattice frame 35 has sufficient mechanical intensity for a support unit that is able to support the diffusing plate 20 and the optical sheet 11. By supporting the diffusing plate 20 and the optical sheet 11 by the lattice frame 35, it is possible to reduce deflection of the diffusing plate 20 and the optical sheet 11. Additionally, in a case where a top end portion of the lattice frame 35, which is fitted with a groove 27, is formed from the rigid material, a space (clearance) is preferably secured between a top end portion of the lattice frame 35 and the groove 27 so that deformation is not caused in the top end portion of the lattice frame 35 or the groove 27.

The lattice frame 35 is preferably able to reflect the light radiated by the LED 15 and is able to be formed from, for example, white PC resin. Furthermore, the lattice frame 35 is also preferably able to transmit the light radiated by the LED 15, and is able to be formed from, for example, transparent PC resin or PMMA resin.

The lattice frame 35 may be formed integrally with the LED substrate 30, may be formed integrally with the outer-periphery frame 31, or may be formed separately from the both.

### Diffusing Plate

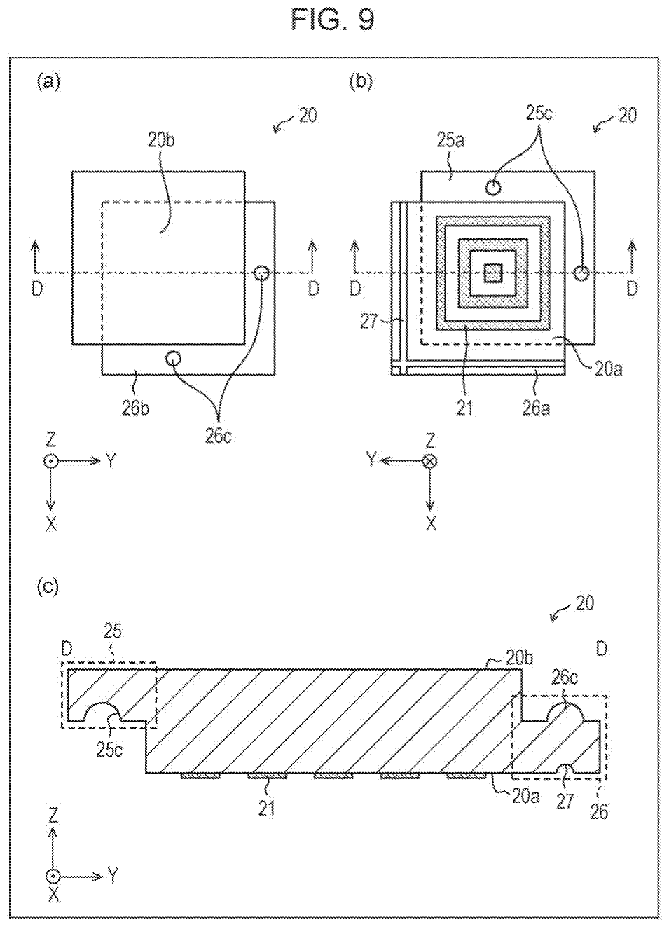

FIGS. 9(a), 9(b), and 9(c) are respectively a top view, a bottom view, and a sectional view as viewed in an arrow direction of D-D, which illustrate a schematic configuration of the diffusing plate 20 illustrated in FIG. 8.

As illustrated in FIGS. 9(a) and 9(c), the diffusing plate 20 according to Embodiment 3 has the projecting portion 26c on a top surface 26b of the lower overlapped portion 26.

As illustrated in FIGS. 9(b) and 9(c), the diffusing plate 20 has the reflection pattern 21 provided on the main incident surface 20a. The diffusing plate 20 has, as the optical member positioning unit, the groove 27 provided on a lower surface 26a of the lower overlapped portion 26, which is in the main incident surface 20a. The diffusing plate 20 has, on a lower surface 25a of the upper overlapped portion 25, the recessed portion 25c that corresponds to the projecting portion 26c.

The groove 27 is disposed so that, when the diffusing plate 20 is put on the lattice frame 35, the lattice frame 35 is fitted with the grove 27. Specifically, a plane shape of the groove 27 is a partial shape of a lattice shape of the lattice frame 35. The casing 17 stores the diffusing plate 20 in such a manner that the groove 27 is fitted with the corresponding lattice frame 35, so that the diffusing plate 20 is positioned with respect to the casing 17.

By being positioned by the fitting of the groove 27 and the lattice frame 35, when expanding or contracting due to a temperature change, the diffusing plate 20 expands or contracts with the groove 27 as a center. Specifically, since the groove 27 is fitted with the lattice frame 35, the diffusing plate 20 that expands or contracts is slid with respect to the casing 17 so that the groove 27 does not move with respect to the lattice frame 35.

The projecting portion 26c and the recessed portion 25c preferably have shapes that are complementary to each other. Moreover, the projecting portion 26c and the recessed portion 25c are arranged so that, when the diffusing plate 20 is put on the lattice frame 35, the projecting portion 26c and the recessed portion 25c of the diffusing plates 20 that are adjacent to each other are fitted. By arranging the diffusing plates 20, which are adjacent to each other, so that the projecting portion 26c is fitted with the corresponding recessed portion 25c, each of the diffusing plates 20 is positioned with respect to a different diffusing plate 20 that is adjacent thereto.

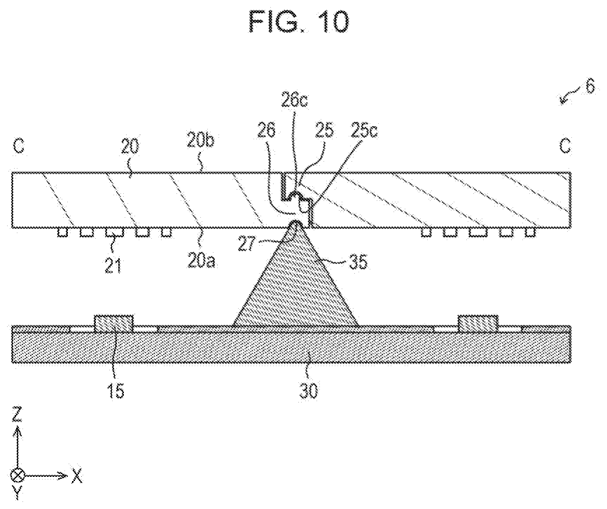

FIG. 10 is a sectional view as viewed in an arrow direction of C-C of FIG. 8(a).

Accordingly, as illustrated in FIG. 10, as to two diffusing plates 20 (a first optical member and a second optical member) that are adjacent to each other, (i) the upper overlapped portion 25 (first overlapped portion) of one diffusing plate 20 (first optical member) is able to be overlapped with the lower overlapped portion 26 (second overlapped portion) of the other diffusing plate 20 (second optical member), (ii) the groove 27 that is disposed on the lower surface 26a of the lower overlapped portion 26 of the other diffusing plate 20 is able to be fitted with the lattice frame 35, and (iii) the recessed portion 25c (first overlapped positioning unit) that is disposed on the upper overlapped portion 25 of the one diffusing plate 20 is able to be fitted with the projecting portion 26c (second overlapped positioning unit) that is disposed on the top surface 26b of the lower overlapped portion 26 of the other diffusing plate 20. Thereby, each of the diffusing plates 20 is positioned with respect to the casing 17 and also positioned with respect to a different diffusing plate 20 that is adjacent thereto.

### EMBODIMENT 4

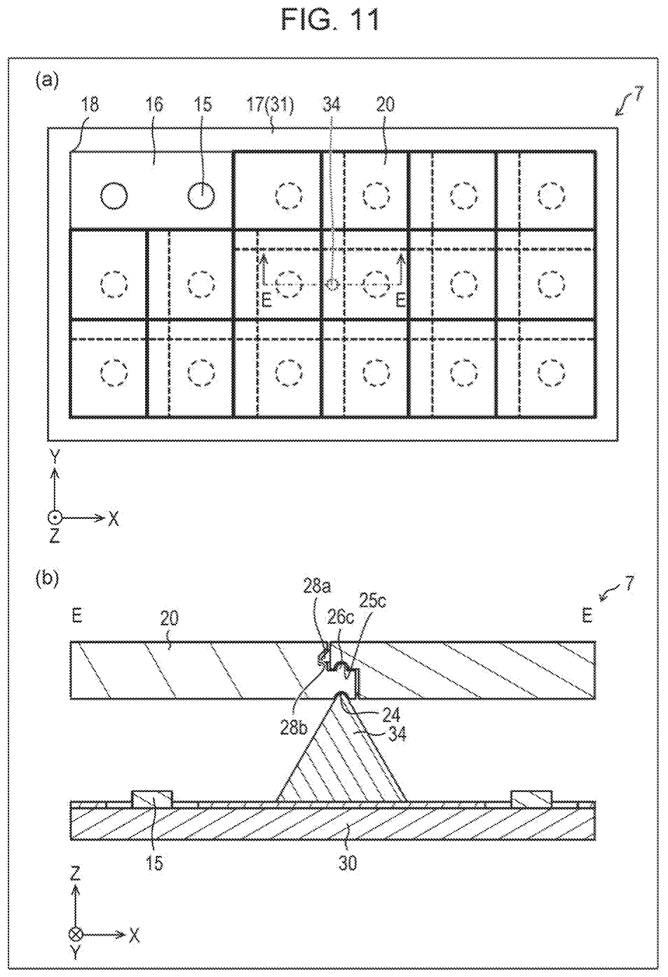

Another embodiment of the invention will be described as follows with reference to FIG. 11. Note that, for convenience of description, a member having the same function as that of the member described in the aforementioned embodiment will be given the same reference sign and description thereof will be omitted.

FIGS. 11(a) and 11(b) are respectively a top view and a sectional view as viewed in an arrow direction of E-E, which illustrate a schematic configuration of a planar lighting module 7 according to Embodiment 4 of the invention. Note that, for convenience of illustration, illustration of the optical sheet 11 and some of the plurality of diffusing plates 20 will be omitted.

As illustrated in FIG. 11, the planar lighting module 7 includes the plurality of LEDs 15, the plurality of diffusing plates 20, the optical sheet 11 (illustration thereof is omitted), and the casing 17.

The schematic configuration of the planar lighting module 7 according to Embodiment 4, which is illustrated in FIG. 11, is different from the schematic configuration of the planar lighting module 6 according to Embodiment 3, which is illustrated in FIG. 8, in three points that (i) the diffusing plate 20 has structures (a claw portion 28a and a claw-receiving portion 28b) to interlock, (ii) the casing 17 does not include the lattice frame 35 but includes the pin frame 34, and (iii) the diffusing plate 20 does not include the groove 27 and some of the diffusing plates 20 include the pin-receiving portion 24, but is similar in other configurations.

### Interlocking Unit

The diffusing plate 20 includes the claw portion 28a (first interlocking unit) on an end surface of the upper overlapped portion 25. The diffusing plate 20 also includes the claw-receiving portion 28b (second interlocking unit) so as to interlock with the claw portion 28a of a different diffusing plate 20 that is adjacent thereto. When the claw portion 28a and the claw-receiving portion 28b interlock with each other, the diffusing plates 20 that are adjacent are engaged with each other. Thereby, the plurality of diffusing plates 20 are combined to be brought into a state of being like one diffusing plate.

By the interlocking of the claw portion 28a and the claw-receiving portion 28b, the diffusing plate 20 is able to be supported through the different diffusing plate 20 that is adjacent thereto. Accordingly, the diffusing plates 20 are not required to be supported one by one, and all or some of the plurality of diffusing plates 20 are able to be collectively supported.

For example, in a case where rigidity of the diffusing plates 20 that are combined, which is obtained by the interlocking of the claw 28a and the claw-receiving portion 28b, is sufficient, it is possible to support the plurality of diffusing plates 20 as in FIG. 11(b). In the case illustrated in FIG. 11(b), the plurality of diffusing plates 20 are supported by one pin frame 34, which is disposed in a center of the LED substrate 30, and the outer-periphery frame 31.

Without limitation thereto, for example, the plurality of diffusing plates 20 may be supported only by the outer-periphery frame 31 or may be supported by a plurality of pin frames 34 and the outer-periphery frame 31, depending on the rigidity of the diffusing plates 20 that are combined.

Accordingly, compared with the planar lighting module according to Embodiment 3 described above, in which the interlocking of the claw portion 28a and the claw-receiving portion 28b is not performed, the planar lighting module 7 according to Embodiment 4, in which the interlocking of the claw portion 28a and the claw-receiving portion 28b is performed, enables simplification of the structure to support the diffusing plates 20. Specifically, in the planar lighting module 7 according to Embodiment 4, the casing 17 is able to include the pin frame 34 instead of the lattice frame 35. Thereby, the planar lighting module 7 according to Embodiment 4 is able to achieve reduction in manufacturing cost and reduction in weight compared with the planar lighting module 6 according to Embodiment 3 described above. Thus, it is preferable that the number of pin frames 34 is small.

### EMBODIMENT 5

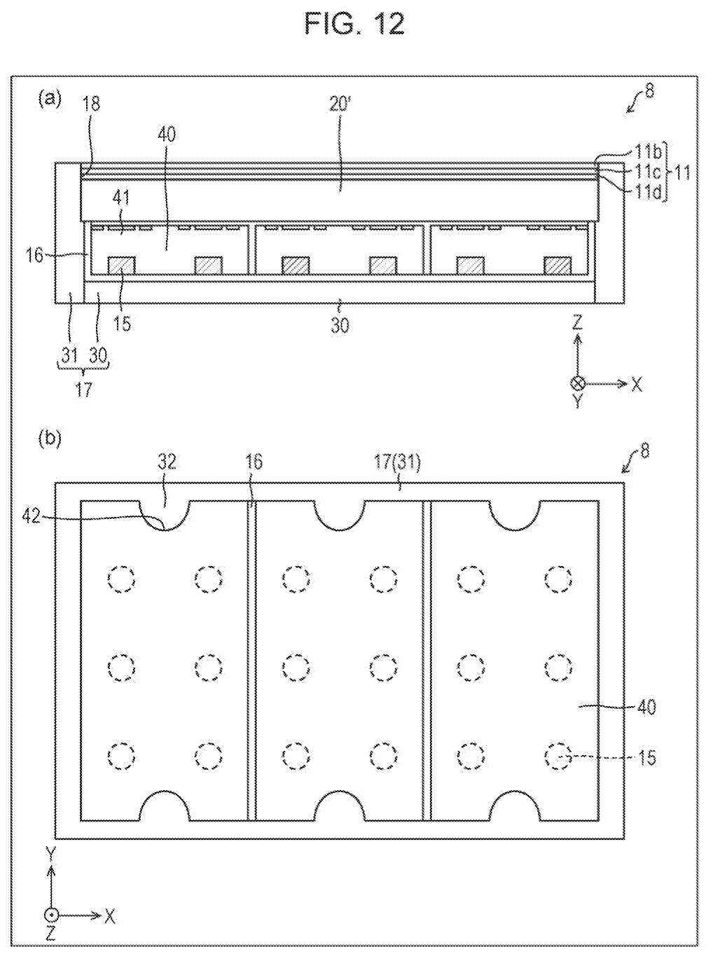

Another embodiment of the invention will be described as follows with reference to FIG. 12. Note that, for convenience of description, a member having the same function as that of the member described in the aforementioned embodiment will be given the same reference sign and description thereof will be omitted.

A light-transmitting pattern may be provided in an optical member other than the diffusing plate 20 and the opening-provided reflection plate 50.

FIGS. 12(a) and 12(b) are respectively sectional view and a top view, which illustrate a schematic configuration of a planar lighting module 8 according to Embodiment 5 of the invention. Note that, for convenience of illustration, illustration of the optical sheet 11 and the diffusing plates 20 will be omitted from FIG. 12(b).

As illustrated in FIG. 12, the planar lighting module 8 includes the plurality of LEDs 15, the diffusing plate 20 which does not include a reflection pattern, the optical sheet 11, the casing 17, and a plurality of light-guide bodies 40 each of which has a reflection pattern 41.

The schematic configuration of the planar lighting module 8 according to Embodiment 5, which is illustrated in FIG. 12, is different from the schematic configuration of the planar lighting module 4 according to Embodiment 1, which is illustrated in FIGS. 1 and 2, in one point of not including the diffusing plate 20 which includes the reflection pattern 21 but including the diffusing plate 20′, which does not include a reflection pattern, and the plurality of light-guide bodies 40 each of which includes the reflection pattern 41, but is similar in other configurations.

### Light Guiding Member

A light guiding member 40 is a light guiding member in which the reflection pattern 41 which is able to reflect light radiated by the LED 15 is disposed on a light transmitting member formed from a transparent material through which the light radiated by the LED 15 is transmitted. The light guiding member 40 has the reflection pattern 41 on a top surface which faces the diffusing plate 20′, so that a light-transmitting pattern included in the light guiding member 40 is complementary to the reflection pattern 41, that is, a pattern reverse to the reflection pattern 41.

The light transmitting member used in the light guiding member 40 expands or contracts in accordance with a temperature change. It is preferable that the light transmitting member used in the light guiding member 40 has high permeability by which the light radiated by the LED 15 is transmitted. Such a light transmitting member is able to be formed from transparent plastic resin, for example, such as polycarbonate (PC) resin, acrylic resin, silicone resin, or polymethyl methacrylate (PMMA) resin, or formed from another transparent material such as glass.

It is preferable that the light guiding member 40 is disposed in such a manner that load is not applied to the LED 15 when the light guiding member 40 expands or contracts due to expansion or contraction caused by a temperature change.

The reflection pattern 41 is a reflection pattern which is formed so as to correspond to arrangement of the LEDs 15 and which is able to reflect the light radiated by the LED 15. In order to uniformize illumination light, it is preferable that the reflection pattern 41 is able to reflect at least light radiated directly above the LED 15.

The number of light-guide bodies 40 is not limited to three, and may be two, or may be four or more.

### Positioning Unit

As illustrated in FIG. 12(b), each of the light-guide bodies 40 includes a notch portion 42 as the optical member positioning unit. Moreover, the casing 17 includes, as the casing positioning unit, the protrusion portion 32 that corresponds to the notch portion 42 in the outer-periphery frame 31. The casing 17 stores the light guiding member 40 in such a manner that the notch portion 42 is fitted with the corresponding protrusion portion 32, so that the light guiding member 40 is positioned with respect to the casing 17.

The notch portion 42 and the protrusion portion 32 that correspond to each other have shapes that are complementary to each other, so that the fitting is allowed. Each of the shapes of the notch portion 42 and the protrusion portion 32 that correspond to each other may be any shape, for example, such as a semicircular shape, a triangular shape, or a rectangular shape.

By being positioned by the fitting of the notch portion 42 and the protrusion portion 32, when expanding or contracting due to a temperature change, the light guiding member 40 expands or contracts with the notch portion 42 as a center. Specifically, since the notch portion 42 is fitted with the protrusion portion 32, the light guiding member 40 that expands or contracts is slid with respect to the casing 17 so that the notch portion 42 does not move with respect to the protrusion portion 32. Thus, the notch portion 42 is preferably provided at each of two end portions of the light guiding member 40, which are opposite to each other, is more preferably provided at the same position of each of the two end portions, and is further more preferably provided at a center of each of the two end portions.

Note that, the optical member positioning unit included in the light guiding member 40 and the casing positioning unit included in the casing 17 may have any structure as long as the fitting with each other is allowed. For example, on the contrary to FIG. 12(b), the light guiding member 40 may include a protrusion portion as the optical member positioning unit and the casing 17 may include a notch portion as the casing positioning unit.

### EMBODIMENT 6

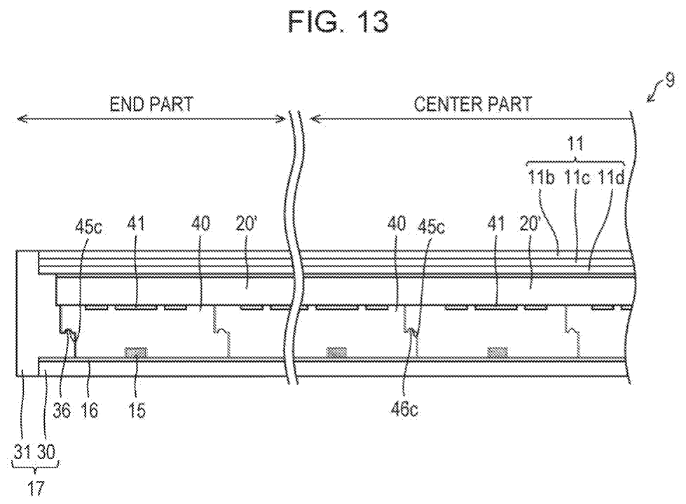

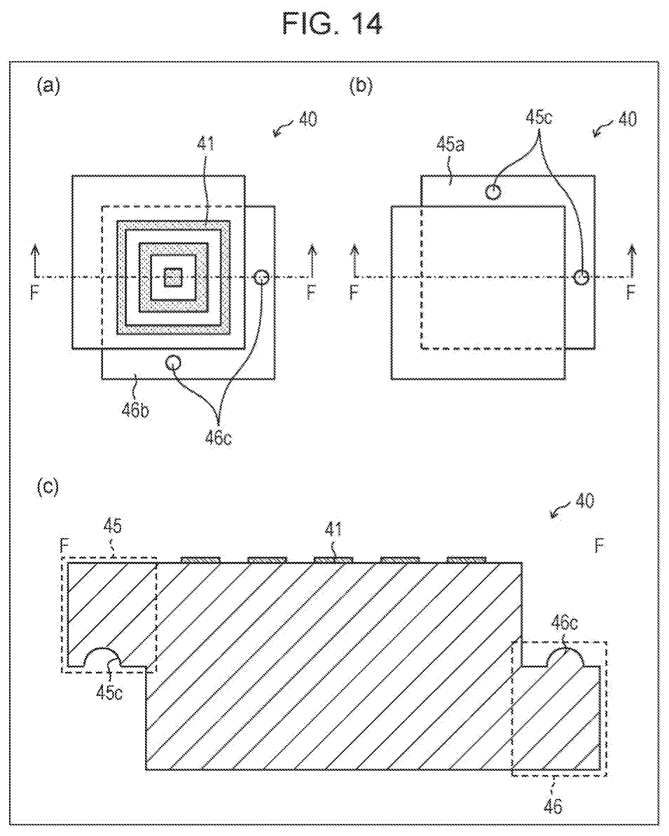

Another embodiment of the invention will be described as follows with reference to FIGS. 13 and 14. Note that, for convenience of description, a member having the same function as that of the member described in the aforementioned embodiment will be given the same reference sign and description thereof will be omitted.

FIG. 13 is a sectional view illustrating a schematic configuration of a planar lighting module 9 according to Embodiment 6 of the invention.

As illustrated in FIG. 13, the planar lighting module 9 includes the plurality of LEDs 15, the diffusing plate 20′ which does not include a reflection pattern, the optical sheet 11, the casing 17, and the plurality of light-guide bodies 40 each of which has the reflection pattern 41.

The schematic configuration of the planar lighting module 9 according to Embodiment 6, which is illustrated in FIG. 13, is different from the schematic configuration the planar lighting module 8 according to Embodiment 5, which is illustrated in FIG. 12, in two points that (i) the light-guide bodies 40 are adjacent to each other in the Y-direction similarly to the X-direction and (ii) structures (a projecting portion 46c and a recessed portion 45c) in which end portions of the light-guide bodies 40 that are adjacent to each other are overlapped and fitted with each other are provided, but is similar thereto in other configurations.

### Light Guiding Member

The light guiding member 40 according to Embodiment 6 further includes the upper overlapped portion 45 and the lower overlapped portion 46 in addition to the reflection pattern 41 and the notch portion 42.

As to two light-guide bodies 40 that are adjacent to each other in the X-direction in FIG. 13, a light guiding member 40 on a left side of FIG. 13 has a lower overlapped portion 46 at a right end, and a light guiding member 40 on a right side of FIG. 13 has an upper overlapped portion 45 at a left end, and the upper overlapped portion 45 and the lower overlapped portion 46 are overlapped with each other in plan view seen from the Z-direction. In this manner, to light guiding member 40 that are adjacent to each other in the X-direction respectively have the upper overlapped portion 45 and the lower overlapped portion 46 that correspond to each other, and the upper overlapped portion 45 and the lower overlapped portion 46 that correspond to each other are overlapped with each other. Thereby, the gap S between the light-guide bodies 40 is divided into a left side of the upper overlapped portion 45 and a right side of the lower overlapped portion 46. Thus, it is difficult that the light radiated by the LED 15 passes through the gap S without being transmitted through the light guiding member 40. Accordingly, a bright point or a bright line due to the gap S is less likely to be generated. Moreover, it becomes easy to enlarge a width of the gap S in the X-direction so that expansion or contraction of a width of the light guiding member 40 in the x-direction is able to be absorbed and a bright point or a bright line is not generated.

As in an example of the configuration illustrated in FIG. 13, it is preferable that the upper overlapped portion 45 or the lower overlapped portion 46 is disposed also at an end portion of a light guiding member 40, which faces the outer-periphery frame 31. This is because the upper overlapped portion 45 or the lower overlapped portion 46 is able to function as the optical member positioning unit by which a light guiding member 40 is positioned with respect to the casing 17. Furthermore, although one light guiding member 40 is disposed for one LED 15 in the example of the configuration illustrated in FIG. 13, one light guiding member 40 may be disposed for a plurality of LEDs 15.

FIGS. 14(a), 14(b), and 14(c) are respectively a top view, a bottom view, and a sectional view as viewed in an arrow direction of F-F, which illustrate a schematic configuration of the light guiding member 40 illustrated in FIG. 13.

As illustrated in FIGS. 14(a) and 14(c), the light guiding member 40 according to Embodiment 6 has the reflection pattern 41 on a top surface. The light guiding member 40 has the projecting portion 46c on a top surface 46b of the lower overlapped portion 46.

As illustrated in FIGS. 14(b) and 14(c), the light guiding member 40 has the recessed portion 45c, which corresponds to the projecting portion 46c, on a lower surface 45a of the upper overlapped portion 45. Moreover, although illustration is omitted, the light guiding member 40 includes, on a lower surface, a hollow in which the LED 15 that is mounted on the LED substrate 30 is stored.

The projecting portion 46c and the recessed portion 45c have shapes that are complementary to each other. Moreover, the projecting portion 46c and the recessed portion 45c are arranged so that the projecting portion 46c and the recessed portion 45c of the light-guide bodies 40 that are adjacent to each other are fitted when light-guide bodies 40 are put on the LED substrate 30.

As illustrated in FIG. 13, by arranging the light-guide bodies 40, which are adjacent to each other, so that the projecting portion 46c is fitted with the corresponding recessed portion 45c, each of the light-guide bodies 40 is positioned with respect to a different light guiding member 40 that is adjacent thereto.

In the example of the configuration illustrated in FIG. 13, a projecting portion 36 that is fitted with the recessed portion 45c is disposed in the outer-periphery frame 31. Thus, in the light guiding member 40 positioned on the left end of FIG. 13, the recessed portion 45c is able to position the light guiding member 40 with respect to the casing 17. That is, the recessed portion 45c is able to function as the optical member positioning unit and the projecting portion 36 is able to function as the casing positioning unit.

### CONCLUSION

A planar lighting device (4 to 9) according to an aspect 1 of the invention includes: a light source unit (LED 15) that radiates light; a plurality of optical members (diffusing plates 20, light-guide bodies 40, opening-provided reflection plates 50) each of which (i) includes a light-transmitting pattern (pattern reverse to a reflection pattern 21, opening pattern of an opening-provided reflection plate 50, pattern reverse to a reflection pattern 41) allowing the light to transmit and (ii) expands or contracts due to a temperature change; and a casing (17) (i) to which the light source unit is fixed, (ii) which includes an opening (18) allowing the light to transmit and which is an optical opening, and (iii) which stores the optical members between the light source unit and the opening, in which at least one of the optical member includes an optical member positioning unit (notch portion 22, pin-receiving portion 24, groove 27, notch portion 42, recessed portion 45c), the casing includes a casing positioning unit (protrusion portion 32, pin frame 34, lattice frame 35, projecting portion 36) that corresponds to the optical member positioning unit, and the at least one of the optical members is positioned with respect to the casing by the optical member positioning unit being fitted with the corresponding casing positioning unit.

According to the aforementioned configuration, each of the optical members includes the light-transmitting pattern and is stored between the light source unit and the opening. Thereby, intensity distribution of light radiated by the light source unit is changed by the light-transmitting pattern included in the optical member and then the light is emitted from the opening. Accordingly, illumination light that is emitted from the opening by the planar lighting device is able to be more uniformized than the light radiated by the light source unit.

According to the aforementioned configuration, the at least one of the optical members expands or contracts due to a temperature change and is positioned with respect to the casing by the fitting of the optical member positioning unit and the casing positioning unit. Thereby, when the optical member expands or contracts due to expansion or contraction caused by the temperature change, the at least one of the optical members moves with respect to the casing so that the optical member positioning unit does not move with respect to the casing positioning unit. Moreover, when the optical member is stored in the casing, it is easy to store the at least one of the optical members at a suitable position with respect to the casing. Accordingly, a size of positional misalignment of the at least one of the optical members with respect to the casing, that is, a size of positional misalignment of the light-transmitting pattern included in the at least one of the optical members with respect to the light source unit is able to be reduced.

According to the aforementioned configuration, the planar lighting device includes the plurality of optical members. That is, the light-transmitting pattern is included in the plurality of optical members in a divided manner. Thereby, compared with a configuration in which the light-transmitting pattern is included in one optical member, it is possible to reduce a degree at which the expansion or contraction of the optical member has influence on the light-transmitting pattern. Specifically, when the optical member expands or contracts due to expansion or contraction of the optical member, the size of the positional misalignment of the light-transmitting pattern with respect to the light source unit is able to be reduced.

Accordingly, it is possible to reduce influence of the expansion or contraction of the optical member, which is caused by a temperature change, on the illumination light emitted by the lighting device. Specifically, since the size of the positional misalignment of the light-transmitting pattern with respect to the light source unit, which is caused by a temperature change, is able to be reduced, unevenness of illumination light, which is caused by the temperature change, is able to be reduced. Accordingly, it is possible to achieve a planar lighting device of a direct type that is adapted to use at a low temperature or a high temperature or in a wide temperature range.

The planar lighting device (4 to 9) according to an aspect 2 of the invention may have a configuration in which the optical members (diffusing plates 20, light-guide bodies 40, opening-provided reflection plates 50) include a first optical member and a second optical member (one and the other of diffusing plates 20 which are adjacent to each other, one and the other of light-guide bodies 40 which are adjacent to each other, one and the other of opening-provided reflection plates 50 which are adjacent to each other) that are adjacent to each other in a direction (X-direction, Y-direction) parallel to an opening plane on which the opening (18) spreads, and a gap (5) is provided between the first optical member and the second optical member, in the aspect 1.

According to the aforementioned configuration, the gap is provided between the first optical member and the second optical member that are adjacent to each other. Thereby, the gap allows absorbing expansion or contraction of the first optical member and the second optical member.

The planar lighting device (4 to 9) according to an aspect 3 of the invention may have a configuration in which the light is allowed to transmit through the gap (S), in the aspect 2.

According to the aforementioned configuration, the light is able to transmit through the gap. Thereby, shadow due to the gap is not generated. Accordingly, the lighting device is able to emit uniform illumination light.

The planar lighting device (5 to 7, 9) according to an aspect 4 of the invention may have a configuration in which the first optical member (one of the diffusing plates 20 which are adjacent to each other, one of the light-guide bodies 40 which are adjacent to each other) includes a first overlapped portion (upper overlapped portion 25, 45), the second optical member (the other of the diffusing plates 20 which are adjacent to each other, the other of the light-guide bodies 40 which are adjacent to each other) includes a second overlapped portion (lower overlapped portion 26, 46) that corresponds to the first overlapped portion, and the first overlapped portion is overlapped at least partially with or in contact with the corresponding second overlapped portion in plan view seen from a direction (Z-direction) orthogonal to the opening plane, in the aspect 2 or 3.

According to the aforementioned configuration, the first optical member and the second optical member that are adjacent to each other include the first overlapped portion and the second overlapped portion that are overlapped with or in contact with each other in plan view. Thereby, the gap S between the first optical member and the second optical member is divided, so that it is difficult that the light radiated by the light source unit transmits through the gap S without being transmitted through the optical member. Accordingly, a part (a bright point or a bright line) in which light intensity is strong due to the gap S is less likely to be generated in intensity distribution of the illumination light.

Thereby, the lighting device is able to emit uniform illumination light. Additionally, the gap is easily provided between the first optical member and the second optical member that are adjacent to each other without impairing uniformity of the illumination light.

The planar lighting device (6 and 7, 9) according to an aspect 5 of the invention may have a configuration in which the first overlapped portion (upper overlapped portion 25, 45) includes a first overlapped positioning unit (recessed portion 25c, 45c), the second overlapped portion (lower overlapped portion 26, 46) includes a second overlapped positioning unit (projecting portion 26c, 46c) that corresponds to the first overlapped positioning unit, and the first optical member is positioned with respect to the second optical member by the first overlapped positioning unit being fitted with the corresponding second overlapped positioning unit, in the aspect 4.

According to the aforementioned configuration, the first optical member expands or contracts due to a temperature change and is positioned with respect to the second optical member by the fitting of the first overlapped positioning unit and the second overlapped positioning unit. Thereby, when the first and the second optical members expand or contract due to expansion or contraction caused by the temperature change, the first optical member moves with respect to the second optical member so that the first overlapped positioning portion does not move with respect to the second overlapped positioning portion. Moreover, when the first and the second optical members are stored in the casing, it is easy to store the first and the second optical members at suitable positions with respect to each other. Accordingly, a size of positional misalignment of the first and the second optical members with respect to the casing, that is, a size of positional misalignment of the light-transmitting pattern with respect to the light source unit is able to be reduced.

The planar lighting device (7) according to an aspect 6 of the invention may have a configuration in which the first optical member (one of the diffusing plates 20 which are adjacent to each other, one of the light-guide bodies 40 which are adjacent to each other) includes a first interlocking unit (claw portion 28a), the second optical member (the other of the diffusing plates 20 which are adjacent to each other, the other of the light-guide bodies 40 which are adjacent to each other) includes a second interlocking unit (claw-receiving portion 28b) that corresponds to the first interlocking unit, and the first optical member is engaged with the second optical member by the first interlocking unit interlocking with the corresponding second interlocking unit, in the aspect 5.

According to the aforementioned configuration, the first optical member is engaged with the second optical member when the first interlocking unit interlocks with the corresponding second interlocking unit. Thereby the first optical member is able to be supported through the second optical member. Thus, it is possible to eliminate a structure to directly support the first optical member. Accordingly, it is possible to reduce a structure to support the plurality of optical members, thus making it possible to achieve reduction in manufacturing cost of the lighting device and reduction in weight thereof.

The planar lighting device (4 to 9) according to an aspect 7 of the invention may have a configuration in which the light source unit (LED 15) includes a plurality of light sources (LEDs 15) driving control of which is performed individually, in any one aspect of the aspects 1 to 6.

According to the aforementioned configuration, the light source unit includes the plurality of light sources driving control of which is performed individually, thus making it possible to perform local dimming drive. Thereby, it is possible to achieve a planar lighting device that is suitable for a backlight of a display device. A display device that includes the planar lighting device having the configuration described above enables contrast of a display image to be enhanced by the local dimming drive of the light source unit.

The planar lighting device (4′) according to an aspect 8 of the invention may have a configuration in which each of the optical members (opening-provided reflection plates 50) includes a reflector that is allowed to reflect the light, and an opening pattern that allows the light to transmit and that penetrates the reflector, and the light-transmitting pattern includes the opening pattern, in any one aspect of the aspects 1 to 7.

The planar lighting device (4, 5 to 9) according to an aspect 9 of the invention may have a configuration in which each of the optical members (diffusing plates 20, light-guide bodies 40) includes a light transmitting member that allows the light to transmit, and a reflection pattern (21, 41) that is allowed to reflect the light and is disposed on the light transmitting member, and the light-transmitting pattern includes a pattern reverse to the reflection pattern, in any one aspect of the aspects 1 to 7.

The planar lighting device (4, 5 to 9) according to an aspect 10 of the invention may have a configuration in which the reflection pattern (21) includes a dot pattern that is printed with white ink, in the aspect 9.

The planar lighting device (4, 5 to 7) according to an aspect 11 of the invention may have a configuration in which the light transmitting member contains a scatterer that is allowed to scatter the light, in the aspect 9 or 10.

According to the aforementioned configuration, the light transmitting member contains the scatterer that is able to scatter light radiated by the light source unit. Thereby, intensity distribution of the light is able to be uniformized because the optical member scatters the light while the light is incident from a main surface of the light transmitting body, which is on a side of the light source unit, and emitted from a main surface of the light transmitting member, which is on a side of the opening.

The planar lighting device (4, 6, 7) according to an aspect 12 of the invention may have a configuration in which the casing positioning unit (pin frame 34, lattice frame 35) includes a support unit that is allowed to support the optical member, in any one aspect of the aspects 1 to 11.

According to the aforementioned configuration, the support unit is able to support the optical member, thus making it possible to reduce deflection of the optical member.

The planar lighting device (4, 7) according to an aspect 13 of the invention may have a configuration in which the casing positioning unit (pin frame 34) includes a pin-shaped protrusion portion that protrudes from the casing (17) toward the optical member (diffusing plate 20) and has a pin shape, in any one aspect of the aspects 1 to 12.

According to the aforementioned configuration, the pin-shaped protrusion portion has the pin shape, thus making it possible to reduce manufacturing cost and weight of the planar lighting device.

The planar lighting device (6) according to an aspect 14 of the invention may have a configuration in which the casing positioning unit (lattice frame 35) includes a lattice-shaped protrusion unit that protrudes from the casing (17) toward the optical member (diffusing plate 20) and has a shape of a wall that is disposed in a lattice pattern in plan view seen from a direction (Z-direction) orthogonal to the opening plane on which the opening (18) spreads, in any one aspect of the aspects 1 to 12.

According to the aforementioned configuration, the lattice-shaped protrusion unit has the lattice shape, thus making it possible to enhance rigidity of the casing.

The planar lighting device (4 to 9) according to an aspect 15 of the invention may have a configuration in which a material from which the casing positioning unit is formed includes an elastic material, in any one aspect of the aspects 1 to 14.

According to the aforementioned configuration, the material from which the casing positioning unit is formed includes the elastic material, so that the casing positioning unit is able to have elasticity. Thereby, the casing positioning unit is able to follow expansion or contraction of the optical member positioning unit, thus making it possible to reduce occurrence of deformation.

A display device according to an aspect 16 of the invention, which includes a planar lighting device, may have a configuration in which the planar lighting device described in any one aspect of the aspects 1 to 15 is included.

According to the aforementioned configuration, it is possible to achieve a display device that includes, as a backlight including the planar lighting device according to the embodiment of the invention.

The invention is not limited to each of the embodiments described above, and may be modified in various manners within the scope indicated in the claims and an embodiment achieved by appropriately combining technical means disclosed in each of different embodiments is also encompassed in the technical scope of the invention. Further, by combining the technical means disclosed in each of the embodiments, a new technical feature may be formed.

### REFERENCE SIGNS LIST

1 liquid crystal display device (display device)
2 cover glass
3 liquid crystal panel
4, 5, 6, 7, 8, 9 planar lighting module (planar lighting device)
11, 11′ optical sheet
11a deflection-reflection sheet
11b first prism sheet
11c second prism sheet
11d first diffusion sheet
11e second diffusion sheet
15, 115 LED (light source unit)
16, 116 reflection sheet
17, 117 casing
18 opening
20, 20′, 120 diffusing plate (optical members)
20a, 50a main incident surface
20b, 50b main emitting surface
21, 41 reflection pattern
22 notch portion (optical member positioning unit)
24 pin-receiving portion (optical member positioning unit)
25, 45 upper overlapped portion (first overlapped portion)
25a, 26a, 45a lower surface
25c, 45c recessed portion (first overlapped positioning unit)
26, 46 lower overlapped portion (second overlapped portion)
26b, 46b upper surface
26c, 36, 46c projecting portion (second overlapped positioning unit)
27 groove (optical member positioning unit)
28a claw portion (first interlocking unit)
28b claw-receiving portion (second interlocking unit)
30 LED substrate
31 outer-periphery frame
32 protrusion portion (casing positioning)
34 pin frame (casing positioning)
34a claw
34b through hole
35 lattice frame (casing positioning)
40 light guiding member (optical member)
50 opening-provided reflection plate (optical member)
S gap

1. A planar lighting device comprising:
a light source unit that radiates light;
a plurality of optical members each of which (i) includes a light-transmitting pattern allowing the light to transmit and (ii) expands or contracts due to a temperature change; and
a casing (i) to which the light source unit is fixed, (ii) which includes an opening allowing the light to transmit and which is an optical opening, and (iii) which stores the optical members between the light source unit and the opening, wherein
at least one of the optical members includes an optical member positioning unit,
the casing includes a casing positioning unit that corresponds to the optical member positioning unit, and
the at least one of the optical members is positioned with respect to the casing by the optical member positioning unit being fitted with the corresponding casing positioning unit.

2. The planar lighting device according to claim 1, wherein
the optical members include a first optical member and a second optical member that are adjacent to each other in a direction parallel to an opening plane on which the opening spreads, and
a gap is provided between the first optical member and the second optical member.

3. The planar lighting device according to claim 2, wherein the light is allowed to transmit through the gap.

4. The planar lighting device according to claim 2, wherein
the first optical member includes a first overlapped portion,
the second optical member includes a second overlapped portion that corresponds to the first overlapped portion, and
the first overlapped portion is overlapped at least partially with or in contact with the corresponding second overlapped portion in plan view seen from a direction orthogonal to the opening plane.

5. The planar lighting device according to claim 4, wherein
the first overlapped portion includes a first overlapped positioning unit,
the second overlapped portion includes a second overlapped positioning unit that corresponds to the first overlapped positioning unit, and
the first optical member is positioned with respect to the second optical member by the first overlapped positioning unit being fitted with the corresponding second overlapped positioning unit.

6. The planar lighting device according to claim 5, wherein
the first optical member includes a first interlocking unit,
the second optical member includes a second interlocking unit that corresponds to the first interlocking unit, and
the first optical member is engaged with the second optical member by the first interlocking unit interlocking with the corresponding second interlocking unit.

7. The planar lighting device according to claim 1, wherein the light source unit includes a plurality of light sources driving control of which is performed individually.

8. The planar lighting device according to claim 1, wherein
each of the optical members includes
a reflector that is allowed to reflect the light, and
an opening pattern that allows the light to transmit and that penetrates the reflector, and
the light-transmitting pattern includes the opening pattern.

9. The planar lighting device according to claim 1, wherein
each of the optical members includes
a light transmitting member that allows the light to transmit, and
a reflection pattern that is allowed to reflect the light and is disposed on the light transmitting member, and
the light-transmitting pattern includes a pattern reverse to the reflection pattern.

10. The planar lighting device according to claim 9, wherein the reflection pattern includes a dot pattern that is printed with white ink.

11. The planar lighting device according to claim 9, wherein the light transmitting member contains a scatterer that is allowed to scatter the light.

12. The planar lighting device according to claim 1, wherein the casing positioning unit includes a support unit that is allowed to support the optical member.

13. The planar lighting device according to claim 1, wherein the casing positioning unit includes a pin-shaped protrusion portion that protrudes from the casing toward the optical member and has a pin shape.

14. The planar lighting device according to claim 1, wherein the casing positioning unit includes a lattice-shaped protrusion unit that protrudes from the casing toward the optical member and has a shape of a wall that is disposed in a lattice pattern in plan view seen from a direction orthogonal to the opening plane on which the opening spreads.

15. The planar lighting device according to claim 1, wherein a material from which the casing positioning unit is formed includes an elastic material.

16. A display device comprising the planar lighting device according to claim 1.
